(19) United States
(12) Patent Application Publication
(10) Pub. No.: US 2003/0131805 A1
(43) Pub. Date: Jul. 17, 2003

(54) Cycle strategies for a hybrid HCCI engine using variable camshaft timing

(76) Inventor: Jialin Yang, Canton, MI (US)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/350,504

(22) Filed: Jan. 24, 2003

Related U.S. Application Data
(63) Continuation of application No. 09/573,743, filed on May 18, 2000, now abandoned.

(51) Int. Cl. F02B 3/00; F01L 1/34

(52) U.S. Cl. 123/27 R; 123/90.17

(57) ABSTRACT

A hybrid homogeneous charge compression ignition and spark ignition engine is disclosed. The engine comprises at least one cylinder including at least one intake valve and at least one exhaust valve. A pair of camshafts is used. The first camshaft is structured and arranged to operate at least one of the intake valves and the second camshaft is structured and arranged to operate at least one of the exhaust valves. The engine also includes a variable camshaft timing device operatively connected to the camshafts for operating the engine in a homogeneous charge compression ignition mode and in a spark ignition mode. A method of operating the homogeneous charge compression ignition and spark ignition engine is also disclosed. The method includes the steps of operating at least one of the intake valves by a first camshaft, operating at least one of the exhaust valves by a second camshaft and determining an engine load condition. The method also includes operating at least one of the camshafts by a variable camshaft timing device based on the determined engine load condition. This allows the engine to operate using homogenous charge compression ignition when the engine is in a low load condition and to operate using spark ignition when the engine is in a high load condition. Operation in the full load condition is also included with and without supercharging or turbocharging.

### BACKGROUND OF THE INVENTION

1. Field of the Invention

This invention relates to a structure and method for providing various cycle strategies in a hybrid homogeneous-charge compression-ignition (HCCI) and spark ignition (SI) engine.

2. Discussion of the Related Art

The homogeneous-charge compression-ignition engine is a relatively new type of engine. It has certain benefits that are attractive such as extremely low NOₓ emissions due to the low combustion temperatures of the diluted mixture and zero soot emissions due to the premixed lean mixture. Also, thermal efficiency of the HCCI engine is much higher than SI engines and is comparable to conventional compression ignition (CI) engines due to the high compression ratio (similar to diesel engines), un-throttled operation (minimizing engine pumping losses), high air fuel ratio (high specific heat ratio), reduced radiation heat transfer loss (without sooting flame), and the low cycle-by-cycle variation of HCCI combustion (since the early flame development and the combustion rate of the HCCI engine does not rely on in-cylinder flow and turbulence).

The difficulty with combustion in an HCCI engine is controlling the ignition timing and the combustion rate at different operating conditions. This is because combustion starts by auto-ignition when the mixture reaches a certain temperature. Thus, the fuel-air mixture is formed earlier before top dead center (TDC), and ignition can occur at any time during the compression process. Thus as the engine load increases, the ignition tends to advance, and the combustion rate tends to increase due to the richer mixture. The thermal efficiency may also decrease due to early heat release before TDC, and the engine becomes rough due to fast and early combustion.

When the engine load decreases, ignition tends to be retarded which may eventually result in misfiring as well as an increase in HC and CO emissions. When engine speed increases, the time for the main heat release tends to be retarded since the time available for low-temperature preliminary reaction of the diluted mixture becomes insufficient and misfiring may occur.

### SUMMARY OF THE INVENTION

An object of this invention is to provide a device that assists in controlling and operating a gasoline powered hybrid HCCI/SI engine over a wide load range including cold start.

It is a further object of the invention to provide a hybrid HCCI/SI engine that can operate at two different cycles under different operating conditions.

It is a further object of the invention to provide a hybrid HCCI/SI engine that can operate using an Atkinson cycle with spark ignition during some conditions and using an HCCI combustion mode during other conditions.

It is a further object of the invention to provide a hybrid HCCI/SI engine with a variable camshaft timing (VCT) strategy for two camshafts.

It is a still further object of the invention to provide an engine with two camshafts that can be individually controlled for better control of the engine.

It is yet another object of the present invention to provide an engine that allows control of NOₓ, HC and Co emissions during high load or high speed operation by controlling the air-fuel ratio to stoichiometric proportion through controlling the IVC timing and using the conventional three-way catalyst.

It is another object of the present invention to achieve high torque output at full load (which can be equal or greater than that of conventional SI engines).

It is still another object of the invention to provide an engine that can use late intake valve closing, supercharging or turbo-charging with intercool, and late spark timing to minimize the peak cylinder pressure and to avoid knock, while the engine torque output is maximized.

This invention is for operating a gasoline-fueled HCCI and spark ignition engine at a wide load range including cold start conditions. It is proposed to apply at least two different cycles under different operating conditions.

Three different cycle strategies are discussed below. In the first cycle strategy, at low load, the engine operates at HCCI combustion mode with a large amount of internal EGR (exhaust gas recycle) or a large amount of residual gases, and a high compression ratio. This requires a large valve overlap or a large gap from the exhaust valve closing to the intake valve opening, and it uses conventional intake valve closing (IVC) timing.

In the second cycle strategy during high load, high speed, or during engine cold start, the engine operates at SI combustion mode with a reduced internal EGR and a reduced effective compression ratio (using an Atkinson cycle). This requires conventional valve overlap and late IVC timing. The IVC timing can be adjusted with the change in load to control the intake air mass so that the mixture can be controlled in a stoichiometric proportion (air-fuel ratio of 14.6). As a result, a conventional three-way catalyst can be used at the exhaust pipe to minimize NOx, CO and HC emissions.

In the third cycle strategy during full load, the engine operates in SI combustion mode with reduced internal EGR. This requires a conventional valve overlap. The effective compression ratio, however, may or may not be reduced depending on whether a supercharge or a turbo-charge is applied (i.e., the Atkinson cycle may or may not be applied).

If a supercharge or a turbo-charge is not applied, the effective compression ratio should not be reduced (the Atkinson cycle is not used), hence the engine has a sufficient volumetric efficiency. To avoid engine knock and to control the peak cylinder pressure, the spark timing should be significantly retarded (as shown in FIG. 5). Conventional IVC timing is applied.

If a supercharge or a turbo-charge with intercool is applied (i.e. cooling the compressed air before it enters the cylinder), the effective compression ratio is reduced (i.e. the Atkinson cycle is used but with a higher intake pressure) to control the intake air mass. Again, the effective compression ratio is reduced by late IVC timing. This cycle is shown in FIG. 6.

At least three different mechanisms can be used to realize these different cycle strategies.

All of the three mechanisms use dual-overhead-cam and unconventional independently-controllable cam timing for each camshaft (dual unequal counter-shifting variable cam timing). The arrangement of the intake and exhaust port(s)/valve(s) can be different.

The first mechanism uses an enlarged intake valve event length (290-330 cad) with a conventional valve/port arrangement and 2, 3 or 4 valves per cylinder. This mechanism can be used to realize all of the cycle strategies except when it is full load and a supercharge or turbocharge is not applied. The port/valve arrangement and the cam phasing and valve timing under two different combustion modes are shown in FIGS. 1, 3, 7 and 8.

The second mechanism uses three valves, two intake valves and one exhaust valve. The port/valve arrangement and valve timing are shown in FIGS. 2, 9, 10 and 11. All the cycle strategies can be realized with this mechanism.

The third mechanism uses four valves. The port/valve arrangement and valve timing are shown in FIGS. 4 and 12-17. All the cycle strategies can be realized with this mechanism.

This invention is proposed for a gasoline-fueled engine with a compression ratio of 12:1-19:1 and preferably 14:1-16:1. This engine is designed to run using an Atkinson cycle with spark ignition during cold start, at high load and at high speed operations. The engine can use late intake valve closing (IVC) in the Atkinson cycle so the effective compression ratio of the engine is reduced to below 10:1 depending on the load while the expansion ratio remains high. The air fuel ratio under this condition is from 12-20 and preferably 14.6 for spark ignition and emission control using a three-way catalyst. After the engine is warmed up and the load is low, the engine cycle is switched to HCCI combustion mode with a high compression ratio and a large amount of hot residuals. The higher compression ratio is achieved by restoring the IVC timing to its normal condition.

The amount of residuals is increased by significantly advancing the intake valve opening (IVO) timing by 20-90 crank angle degrees (cad) from the normal IVO timing of conventional engines and by retarding the exhaust valve closing (EVC) timing. A very early IVO timing allows a large amount of exhaust gas to flow into the intake port and flow back into the cylinder during the intake process. A late EVC allows the exhaust gases to flow back into the cylinder.

In this invention, the event length of the intake cam can be enlarged to 290-330 cad. In contrast, the event length of a conventional engine is only about 240-270 cad and typically is 248 cad for automotive engines (Ford 2.0L ZETA). The phasing of both camshafts can be variable based on a dual unequal counter-shifting variable camshaft timing (VCT) strategy. The ranges of phase shifting for the two camshafts can be different. The maximum phase shifting range for the intake camshaft is about 20-90 cad. However, the maximum phase shifting range for the exhaust camshaft is only about 10-30 cad. Thus if the phase shifting mechanism of the two camshafts is connected, the shifting rates have to be different with a ratio of about 3-8, in counter directions.

For the HCCI combustion mode, the phase of the intake camshaft is advanced with IVO at 40-110 cad before top dead center (bTDC) and IVC at 20-40 cad after bottom dead center (aBDC). Further, the phase of the exhaust camshaft is retarded with EVC at 30-60 aTDC and EVO at 20-40 cad bBDC. Both the delay of IVC and the advance of EVO are smaller than conventional engines because HCCI combustion mode usually is applied at low engine speed. For spark ignition combustion during cold start or high load operations, the phase of the intake camshaft is retarded with IVO at 5-20 cad bTDC and IVC at 80-120 cad aBDC. Also, the phase of the exhaust camshaft is advanced to conventional timings with EVC at 15-30 cad aTDC and EVO at 40-60 cad bBDC.

At full load, the IVC timing is retarded to reduce the effective compression ratio and control the intake air mass. The late IVC combining with supercharging or turbocharging with intercool and late spark timing can control the peak cylinder pressure, avoid knock and provide sufficient torque output.

The proposed techniques can also be used to extend the load range of HCCI combustion and to control autoignition timing. As the load increases, autoignition tends to advance so the phase of the intake camshaft is retarded to decrease both the effective compression ratio and the hot residuals. Also, advancing the exhaust camshaft phasing can reduce trapped hot residuals. Thus, with the lower compression ratio and a lower amount of hot residuals, the autoignition can remain in an optimum timing range.

The above primary proposal of unequal counter shifting VCT assumes that the intake and exhaust shafts are mechanically connected for phase shifting. The phasing of both camshafts affects residuals, the intake camshaft phasing affects the effective compression ratio, and in contrast, the exhaust camshaft phasing affects the expansion ratio. In an alternative embodiment disclosed it is also proposed to individually control the two camshafts for achieving better control of the engine. In addition, the intake camshaft VCT can be applied without control of the exhaust camshaft since the effect of adjusting the effective compression ratio is more important.

To operate the camshaft phasing, feedback control can be included. An optical sensor or pressure transducers can be used to accomplish this purpose. If the phasing is to early, then it can be adjusted to delay the phasing and if it is too late, the camshaft phasing can be advanced.

The combustion phasing in an operating engine can be detected by using a cylinder pressure transducer or an optical luminosity sensor. The information of combustion phasing can be used for feedback control of the cam phasing through engine control units.

The above objects are achieved, and the prior approaches are overcome by a hybrid homogeneous charge compression ignition and spark ignition engine. The hybrid engine comprises at least one cylinder including at least one intake valve and at least one exhaust valve. A first camshaft and a second camshaft are provided such that the first cam shaft is structured and arranged to operate at least one intake valve and the second cam shaft is structured and arranged to operate at least one exhaust valve. A variable camshaft timing device is operatively connected to the camshafts for operating the engine in a homogeneous charge compression ignition mode and in a spark ignition mode.

The objects of the invention are also accomplished by a hybrid HCCI/SI engine comprising at least one cylinder including two intake valves and two exhaust valves. The engine also includes a first camshaft and a second camshaft wherein the first camshaft is structured and arranged to operate one of the intake valves and one of the exhaust valves. The second camshaft is structured and arranged to operate the other of the intake valves and the exhaust valve. A variable camshaft timing device is included for operating the engine in a homogeneous charge compression ignition mode and in a spark ignition mode. The variable camshaft timing device being structured and arranged for causing a large valve overlap condition in the homogeneous charge compression ignition mode by allowing at least one of the intake valves to open before the exhaust valve closes. The variable camshaft timing device is further structured and arranged for causing at least one of the intake valves to close in the range of 70-110 crank angle degrees after bottom dead center in the spark ignition mode.

The objects of the invention are also accomplished by a method of operating a hybrid homogeneous charge compression ignition and spark ignition engine. The method includes the steps of operating at least one of the intake valves by a first camshaft, operating at least one of the exhaust valves by a second camshaft and determining an engine load condition. The method also includes operating at least one of the camshafts by a variable camshaft timing device based on the engine load condition determined in the step of determining so that the engine can operate using homogenous charge compression ignition when the engine is in a low load condition and can operate using spark ignition when the engine is in a high load condition.

### BRIEF DESCRIPTION OF THE DRAWINGS

The above and other objects and features of the present invention will be clearly understood from the following description with respect to a preferred embodiments thereof when considered in conjunction with the accompanying drawings, wherein the same reference numerals have been used to denote the same or similar parts or elements, and in which:

FIG. 1 is a schematic view of a cylinder in a hybrid engine with one intake valve and one exhaust valve according to the present invention.

FIG. 2 is a schematic view of a cylinder in a hybrid engine with two intake valves and one exhaust valve according to the present invention.

FIG. 3 is a schematic view of a cylinder in a hybrid engine with two intake valves and two exhaust valves according to the present invention.

FIG. 4 is a schematic view of a cylinder in a hybrid engine with two intake valves and one exhaust valve according to the present invention.

FIG. 5 is a graph of volume and pressure for the combustion cycle under ideal conditions at full load without supercharging or turbocharging according to the present invention.

FIG. 6 is another graph of volume and pressure for the combustion cycle under ideal conditions at full load when using a supercharger with intercooling according to the present invention.

FIG. 7 is a schematic view of the valve timing during the HCCI combustion mode at low to medium loads when using the valve/port arrangement shown in FIGS. 1 and 3 according to the present invention.

FIG. 8 is a schematic view of the valve timing during the SI combustion mode at high loads and during cold start when using the valve/port arrangement shown in FIGS. 1 and 3 according to the present invention.

FIG. 9 is a schematic view of the valve timing during the HCCI combustion mode at low to medium loads when using the valve/port arrangement shown in FIG. 2 according to the present invention.

FIG. 10 is a schematic view of the valve timing during the SI combustion mode at high loads and during cold start loads when using the valve/port arrangement shown in FIG. 2 according to the present invention.

FIG. 11 is a schematic view of the valve timing during the SI combustion mode at full load loads when using the valve/port arrangement shown in FIG. 2 according to the present invention.

FIG. 12 is a schematic view of the valve timing during the HCCI combustion mode at low to medium loads when using the valve/port arrangement shown in FIG. 4 according to the present invention.

FIG. 13 is a schematic view of the valve timing during the SI combustion mode at high loads and during cold start when using the valve/port arrangement shown in FIG. 4 according to the present invention.

FIG. 14 is a schematic view of the valve timing during the SI combustion mode at full load when using the valve/port arrangement shown in FIG. 4 according to the present invention.

FIG. 15 is a schematic view of the valve timing during the HCCI combustion mode at low to medium loads when using the valve/port arrangement shown in FIG. 4 according to an alternative operation strategy of the present invention.

FIG. 16 is a schematic view of the valve timing during the SI combustion mode at high loads and during cold start when using the valve/port arrangement shown in FIG. 4 according to an alternative operation strategy of the present invention.

FIG. 17 is a schematic view of the valve timing during the SI combustion mode at full load when using the valve/port arrangement shown in FIG. 4 according to an alternative operation strategy of the present invention.

### DETAILED DESCRIPTION OF THE PREFERRED EMBODIMENTS

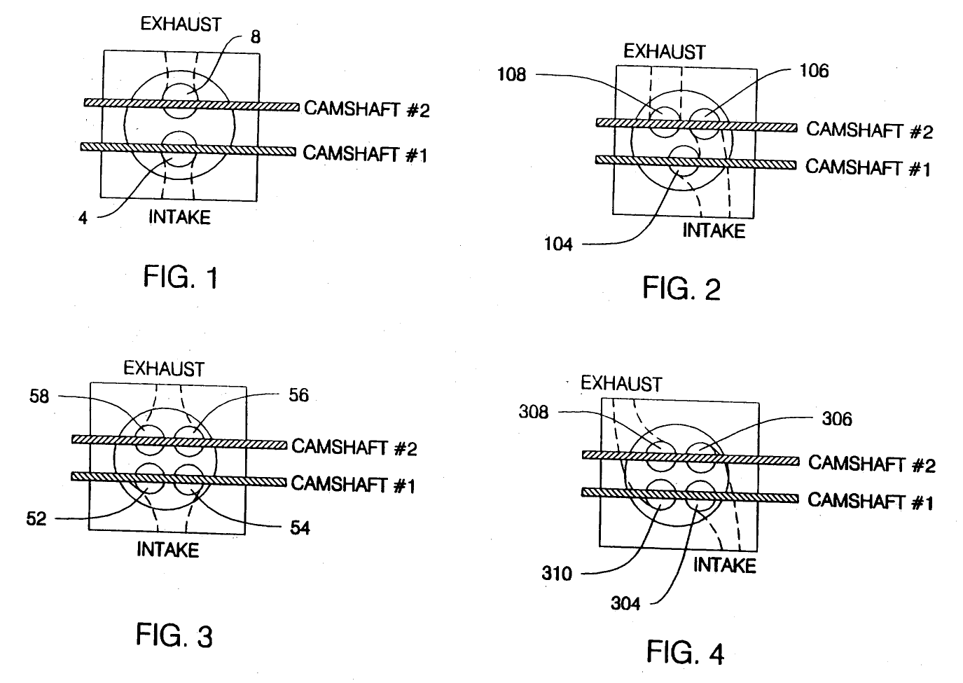

FIGS. 1-4 disclose different representative cylinder arrangements that may be used in a hybrid homogeneous charge compression ignition and spark ignition engine. These different cylinder arrangements will be discussed initially followed by a description of the valve timing arrangements that are used to operate the engine.

FIG. 1 discloses a first type of representative cylinder in the hybrid homogeneous charge compression ignition and spark ignition engine having one intake valve 4 and one exhaust valve 8. The intake valve 4 is operated by a camshaft #1 and the exhaust valve 8 is operated by a camshaft #2.

FIG. 2 discloses a second type of representative cylinder in the hybrid homogeneous charge compression ignition and spark ignition engine having two intake valves 104 and 106 and one exhaust valve 108. The intake valve 104 is operated by a camshaft #1 and the intake valve 106 and the exhaust valve 108 are operated by a camshaft #2.

FIG. 3 discloses a third type of representative cylinder in the hybrid homogeneous charge compression ignition and spark ignition engine having two intake valves 52 and 54 and two exhaust valves 56 and 58. The intake valves 52 and 54 are operated by camshaft #1 and the exhaust valves 56 and 58 are operated by camshaft #2.

FIG. 4 discloses fourth type of representative cylinder using two camshafts #1 and #2 with two intake valves 304 and 306 and two exhaust valves 308 and 310. As shown, intake valve 304 and exhaust valve 310 are disposed on camshaft #1 and intake valve 306 and exhaust valve 308 are disposed on camshaft #2.

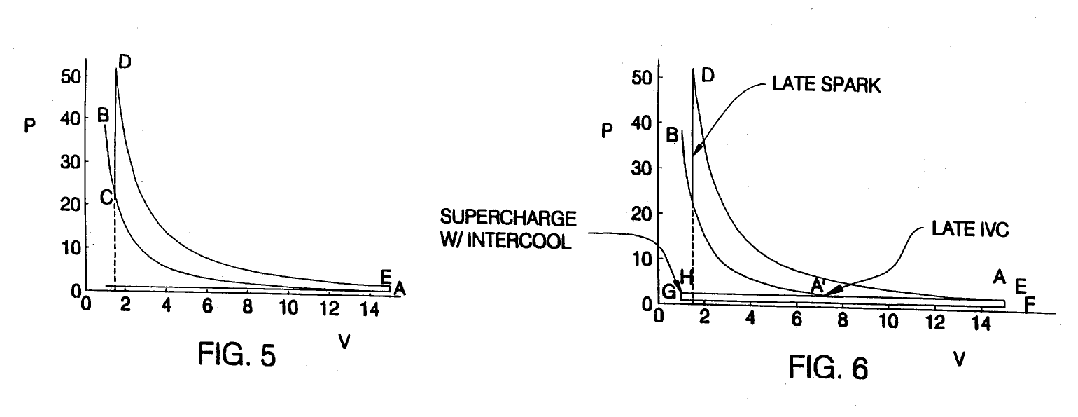

FIG. 5 discloses a volume vs. pressure graph for the combustion cycle under ideal conditions. The compression ratio of a gasoline-fueled HCCI engine should be much higher than that of conventional spark ignition engines for promoting autoignition and increasing fuel efficiency. To operate the HCCI engine at full load, a full-load cycle for spark ignition combustion is proposed as shown in FIG. 5. The valve timing at this combustion mode is similar to conventional engines so that volumetric efficiency of the engine can remain high. By considerably retarding the ignition timing (for example, ignition at 18.5 crank angle degrees after top dead center as shown in FIG. 2), the engine can be operated at the same thermal efficiency as that of conventional spark ignition engines without knocking.

FIG. 5 shows the combustion cycle where the base line is 1 atmosphere pressure and point a is reached at the end of the intake at bottom dead center (BDC). Compression then starts and the volume is reduced and the pressure increased until point b at top dead center (TDC). The pressure then begins to fall after TDC and ignition occurs at point c raising the pressure to point d. Point d indicates the end of combustion and then the pressure decreases and the volume increases to point e due to expansion and then the exhaust valve starts to open. From point e to point a, blow down occurs and then the cycle can repeat.

The key for combustion is to wait until after TDC and here the example uses 18.5 cad aTDC. In general, there are two criteria that should be considered. First, if knocking occurs, the timing is retarded. Second, if the peak pressure is limited, the timing is retarded.

The Atkinson cycle (not shown) is used during SI combustion at high load. FIG. 6 shows the cycle for full load where a supercharger or a turbocharger with intercooling is used. This graph shows that late IVC is used and a late spark is generated.

According to the present invention, three cycles can be used to operate the engine and are proposed as shown in the figures. It should be noted that it is possible to operate the engine with the only HCCI mode and the spark ignition mode at high load without using the spark ignition mode at full load. The following valve timing strategies can be used with two, three or four valves per cylinder. With the “dual unequal counter-shifting variable cam timing” strategies, desirable valve timing can be realized.

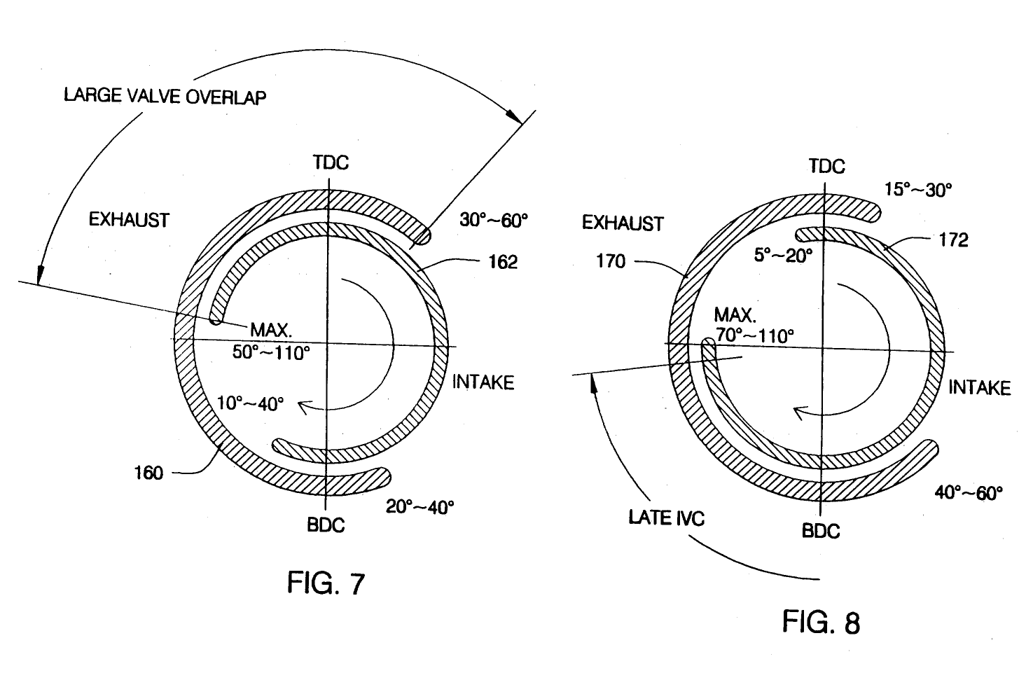

FIGS. 7 and 8 disclose the operation when the engine using the arrangements shown in FIGS. 1 and 3 are used and operating in the HCCI mode. As shown, region 160 illustrates the operation of the exhaust valve(s) that opens approximately 20-40 degrees before BDC and closes approximately 30-60 degrees after TDC. Region 162 illustrates the operation of the intake valve(s) that opens 50-110 degrees before TDC and closes approximately 10-40 degrees after BDC.

As can be seen from FIG. 7, there is a large valve overlap between the opening of the intake valve(s) and the closing of the exhaust valve(s). This overlap helps to boost the cylinder temperature during HCCI ignition. Also, since the local air fuel ratio is low, a lean mixture is used and combustion is maintained below 1800 K so only low levels of NOₓ are produced.

At approximately half load, HCCI becomes impractical due to knocking. This is due in part to the fact that at higher loads, the air fuel mixture becomes richer and the combustion becomes too fast and causes vibration and knocking.

Therefore, to prevent knocking and achieve other benefits, the control of the engine switches to operate the engine in the spark ignition mode at higher loads. This control is shown by FIG. 8. As shown, region 170 illustrates the operation of the exhaust valve(s) that opens approximately 40-60 degrees before BDC and closes approximately 15-30 degrees after TDC. Region 222 illustrates the operation of the intake valve(s) that opens slightly before TDC (5-20 degrees) and closes 70-110 degrees after BDC.

As can be seen from FIG. 8, there is a much lower valve overlap between the opening of the intake valve and the closing of the exhaust valve.

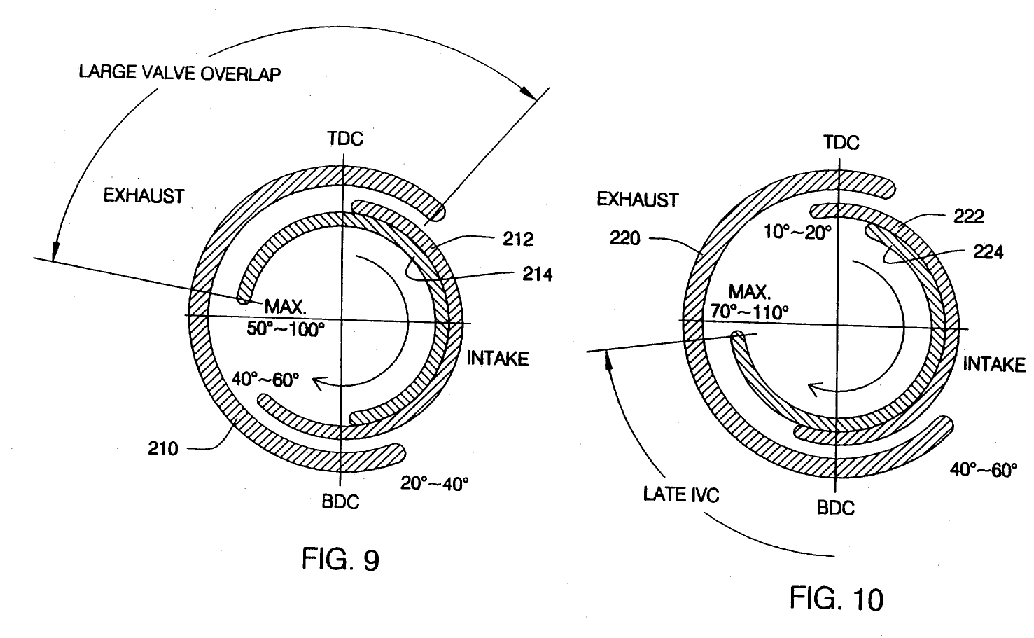

FIGS. 9-11 discloses three possible modes of operation using an arrangement with two intake valves and one exhaust valve as shown in FIG. 2. This system uses dual unequal counter-shifting variable cam timing to achieve variable effective compression ratios and variable valve overlap.

FIG. 9 shows the operation when the engine is operating in HCCI mode with high exhaust gas recirculation. As shown, region 210 illustrates the operation of the exhaust valve 108 that opens approximately 20-40 degrees before BDC and closes approximately 30-50 degrees after TDC. Region 212 illustrates the operation of the intake valve 106 that opens slightly after TDC and closes approximately 40-60 degrees after BDC. Region 214 illustrates the operation of the intake valve 104 that opens 50-110 degrees before TDC.

As can be seen from FIG. 9, there is a large valve overlap between the opening of the intake valve 104 and the closing of the exhaust valve 108. This overlap helps to boost the cylinder temperature during HCCI ignition. Also, since the local air fuel ratio is low, a lean mixture is used and combustion is maintained below 1800 K so only low levels of NOₓ are produced.

As mentioned above, at approximately half load, HCCI becomes impractical due to knocking. Therefore, to prevent knocking and achieve other benefits, the control of the engine switches to operate the engine in the spark ignition mode at higher loads. This control is shown by FIG. 10. As shown, region 220 illustrates the operation of the exhaust valve 108 that opens approximately 40-60 degrees before BDC and closes approximately 15-30 degrees after TDC. Region 222 illustrates the operation of the intake valve 106 that opens slightly before TDC (10-20 degrees) and closes slightly after BDC. Region 224 illustrates the operation of the intake valve 104 that opens slightly after TDC and closes approximately 70-110 degrees after BDC.

As can be seen from FIG. 10, there is a much lower valve overlap between the opening of the intake valve and the closing of the exhaust valve. Also, the intake valve closing shown in region 224 is closed very late so that the compression rate is reduced.

FIG. 11 illustrates the valve timing control used at full load. Basically this arrangement is similar to FIG. 10 except that the timing of the intake valve 104 as shown by region 234 has been changed. As seen in FIG. 11, the opening of the intake valves basically coincide as shown by regions 232 and 234. Further, the intake valve 104 will now close approximately 50-70 degrees after BDC. This allows a controllable compression ratio that can trap more air and provide more power than using the valve timing according to FIG. 10.

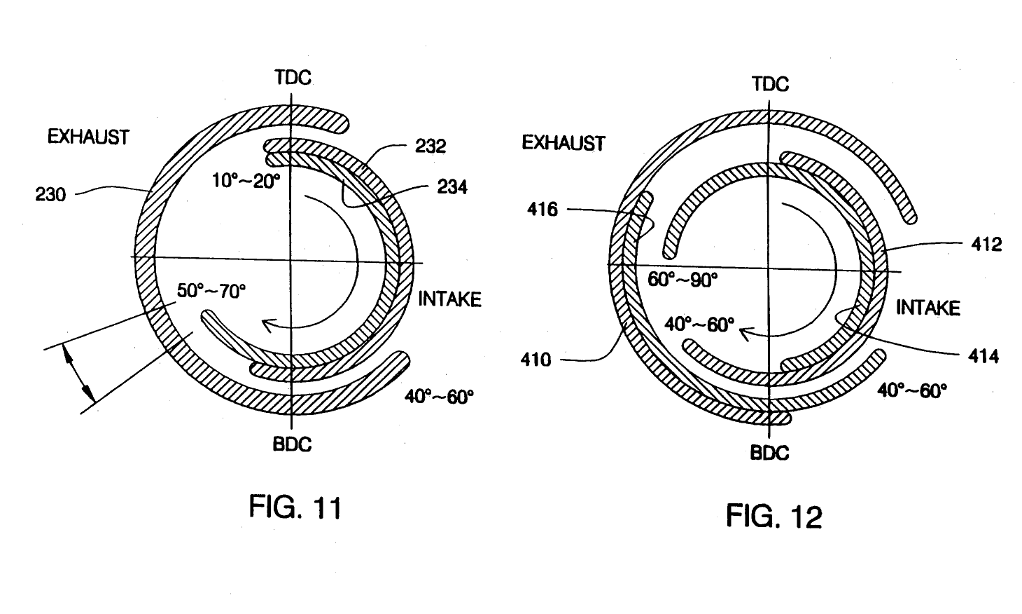

One method of operation of the engine using two intake valves 304 and 306 and two exhaust valves 308 and 310, shown in FIG. 4, is shown in FIGS. 12-14.

FIG. 12 shows the operation of the engine in HCCI mode at low to medium loads. Region 410 illustrates the operation of exhaust valve 308 which opens slightly before BDC and closes approximately 40-80 degrees after TDC. Region 416 illustrates the operation of exhaust valve 310 which is opened approximately 40-60 degrees before BDC and closes before TDC. Region 412 relates to the operation of intake valve 306 which opens slightly after TDC and closes approximately 40-60 degrees after BDC. Further, region 414 relates to intake valve 304 which opens approximately 60-90 degrees before TDC and closes slightly before BDC. This operation has a large valve overlap with more internal exhaust gas recirculation (EGR) and a high compression ratio.

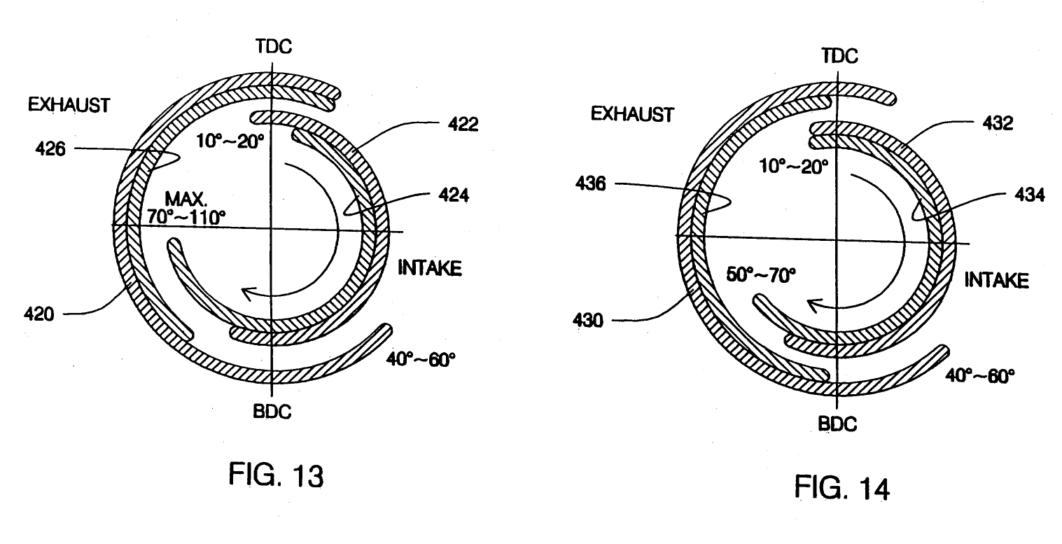

FIG. 13 shows operation in the spark ignition mode during high loads and cold start operation. As shown, region 420 illustrates the operation of exhaust valve 308 which opens approximately 40-60 degrees before BDC and closes approximately 15-30 degrees after TDC. Region 426 illustrates the operation of exhaust valve 310 which is opened after BDC and closes approximately the same time as exhaust valve 308. Region 422 relates to the operation of intake valve 306 which opens approximately 10-20 degrees before TDC and closes slightly after BDC. Further, region 424 relates to intake valve 304 which opens slightly after TDC and closes approximately 70-110 degrees after BDC. This operation mode has normal valve overlapping and a low effective compression ratio and avoids knocking.

FIG. 14 discloses operation of the engine with spark ignition mode at full load. Region 430 illustrates the operation of exhaust valve 308 which opens approximately 40-60 degrees before BDC and closes approximately 15-30 degrees after TDC. Region 436 illustrates the operation of exhaust valve 310 which is opened after BDC and closes slightly before TDC. Region 432 relates to the operation of intake valve 306 which opens approximately 10-20 degrees before TDC and closes slightly after BDC. Further, region 434 relates to intake valve 304 which opens approximately 10-20 degrees before TDC and closes approximately 50-70 degrees after BDC. This operation mode also has normal valve overlapping and a high compression ratio with late ignition. This method should be used with a turbocharger or supercharger with an intercooler for proper operation.

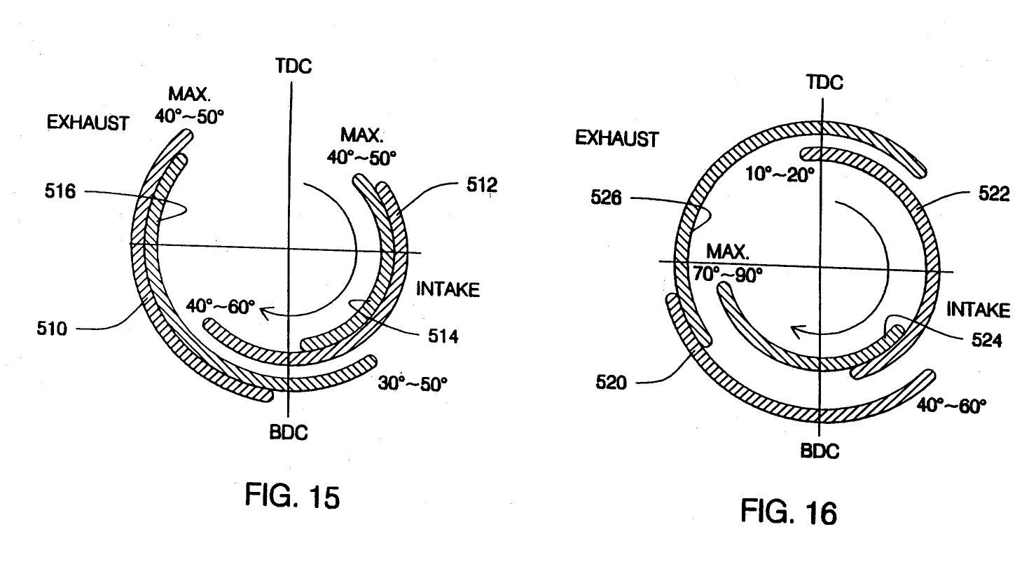

FIGS. 15-17 disclose another embodiment of the preferred invention using two intake valves 304 and 306 and two exhaust valves 308 and 310 as shown in FIG. 4.

FIG. 15 shows the operation of the engine in HCCI mode at low to medium loads. Region 510 illustrates the operation of exhaust valve 308 which opens slightly after BDC and closes approximately 40-50 degrees before TDC. Region 516 illustrates the operation of exhaust valve 310 which is opened approximately 30-50 degrees before BDC and closes before exhaust valve 308. Region 514 relates to the operation of intake valve 304 which opens approximately 40-50 degrees after TDC and closes slightly before BDC. Further, region 512 relates to intake valve 306 which opens slightly after intake valve 304 and closes approximately 40-60 degrees after BDC. This operation has a large gap with no valve overlap between the exhaust valves closing and the intake valves opening. This creates more hot residuals and operates with a high compression ratio.

FIG. 16 shows operation in the spark ignition mode during high loads and cold start operation. As shown, region 520 illustrates the operation of exhaust valve 308 which opens approximately 40-60 degrees before BDC and closes shortly after exhaust valve 310 opens. Region 526 illustrates the operation of exhaust valve 310 which is opened shortly before exhaust valve 308 is closed and closes approximately 35-45 degrees after TDC. Region 522 relates to the operation of intake valve 306 which opens approximately 10-20 degrees before TDC and closes slightly before intake valve 304 opens. Further, region 524 relates to intake valve 304 which opens slightly after intake valve 306 closes and closes approximately 70-90 degrees after BDC. This operation mode has a large degree of valve overlapping and a low effective compression ratio so that it avoids knocking.

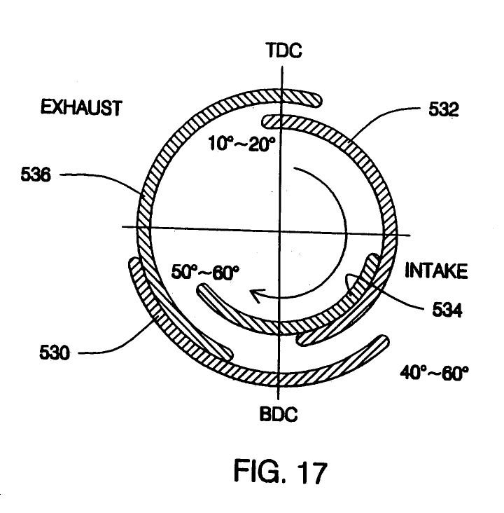

FIG. 17 discloses operation of the engine with spark ignition mode at full load. Region 530 illustrates the operation of exhaust valve 308 which opens approximately 40-60 degrees before BDC and closes between BDC and TDC. Region 536 illustrates the operation of exhaust valve 310 which is opened after BDC and closes approximately 15-20 degrees after TDC. Region 532 relates to the operation of intake valve 306 which opens approximately 10-20 degrees before TDC and closes slightly after BDC. Further, region 534 relates to intake valve 304 which opens between TDC and BDC and closes approximately 50-60 degrees after BDC. This operation mode also has normal valve overlapping and a high compression ratio with late ignition.

The volume-pressure graph of the operation of the ideal ignition cycle for the embodiment shown in FIG. 15 is slightly different from the cycle shown in FIGS. 7, 9 and 12 due to the operation of the valves in these embodiments.

The purpose for these different embodiments is different. For those shown in FIGS. 7, 9 and 12, the purpose is for increasing internal EGR. Because of large valve overlap, more burnt gases flows back to the cylinder. For the other one shown in FIG. 15, the purpose is to trap more hot residuals in the cylinder without gases flowing out the cylinder then flowing back. This is achieved by early exhaust valve closing to retain some burnt gases not to exhaust. The gases in the cylinder are then compressed, followed by expansion. When the pressure reduced to ambient pressure, the intake valve opens to start the intake process. Therefore, there is a gap from EVC to IVO, rather than an overlap.

While the invention has been shown with two camshafts other arrangements are possible. Also, it is possible to operate the camshafts so that the intake and exhaust valves could be separately controlled.

It should also be appreciated that the exact point of changeover from the HCCI combustion mode to the spark ignition combustion mode is dependent on the exact type and size of the engine and would be readily determinable by testing of various loads.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

What is claimed is:

1. A hybrid homogeneous charge compression ignition and spark ignition engine, comprising:
at least one cylinder including at least one intake valve and at least one exhaust valve;
a first camshaft and a second camshaft wherein said first cam shaft is structured and arranged to operate said at least one intake valve and said second cam shaft is structured and arranged to operate said at least one exhaust valve; and
a variable camshaft timing device operatively connected to said camshafts for operating said engine in a homogeneous charge compression ignition mode and in a spark ignition mode.

2. A hybrid engine as defined in claim 1, wherein said at least one exhaust valve comprises a pair of exhaust valves, said exhaust valves being structured and arranged so that one of said exhaust valves is operated by said first camshaft and the other of said exhaust valves is operated by said second camshaft.

3. A hybrid engine as defined in claim 1, wherein said at least one intake valve comprises a pair of intake valves, said intake valves being structured and arranged so that one of said intake valves is operated by said first camshaft and the other of said intake valves is operated by said second camshaft.

4. A hybrid engine as defined in claim 1, wherein said variable camshaft timing device is structured and arranged for causing a large valve overlap condition in the homogeneous charge compression ignition mode by allowing said at least one intake valve to open before said at least one exhaust valve closes.

5. A hybrid engine as defined in claim 4, wherein the valve overlap condition is at least 50 crank angle degrees.

6. A hybrid engine as defined in claim 5, wherein the valve overlap condition is at least 80 crank angle degrees.

7. A hybrid engine as defined in claim 4, wherein the valve overlap condition is in the range of 80-160 crank angle degrees.

8. A hybrid engine as defined in claim 1, wherein said variable camshaft timing device is structured and arranged for causing an intake valve event length to be greater than 250 crank angle degrees.

9. A hybrid engine as defined in claim 8, wherein said variable camshaft timing device is structured and arranged for causing the intake valve event length to be between 290-330 crank angle degrees.

10. A hybrid engine as defined in claim 1, wherein said at least one intake valve includes a pair of intake valves and said at least one exhaust valve includes a pair of exhaust valves and said first camshaft is structured and arranged to operate said pair of intake valves and said second camshaft is structured and arranged to operate said pair of exhaust valves.

11. A hybrid homogeneous charge compression ignition and spark ignition engine, comprising:
at least one cylinder including two intake valves and two exhaust valves;
a first camshaft and a second camshaft wherein said first camshaft is structured and arranged to operate one of said intake valves and one of said exhaust valves, said second camshaft is structured and arranged to operate the other of said intake valves and said exhaust valve; and
a variable camshaft timing device for operating said engine in a homogeneous charge compression ignition mode and in a spark ignition mode, said variable camshaft timing device being structured and arranged for causing a large valve overlap condition in the homogeneous charge compression ignition mode by allowing at least one of said intake valves to open before said exhaust valve closes, said variable camshaft timing device is further structured and arranged for causing at least one of said intake valves to close in the range of 70-110 crank angle degrees after bottom dead center in the spark ignition mode.

12. A hybrid engine as defined in claim 11, wherein the valve overlap condition in the homogeneous charge compression mode is in the range of 80-160 crank angle degrees.

13. A method of operating a hybrid homogeneous charge compression ignition and spark ignition engine, the engine having at least one cylinder including at least one intake valve and at least one exhaust valve, said method comprising the steps of:
operating at least one of the intake valves by a first camshaft;
operating at least one of the exhaust valves by a second camshaft;
determining an engine load condition;
operating at least one of the camshafts by a variable camshaft timing device based on the engine load condition determined in said step of determining so that the engine can operate using homogenous charge compression ignition when the engine is in a low load condition and can operate using spark ignition when the engine is in a high load condition.

14. A method of operating an engine as defined in claim 13, further comprising the step of causing a large valve overlap condition by the variable camshaft timing device by allowing at least one of the intake valves to open before the exhaust valve closes.

15. A method of operating an engine as defined in claim 14, wherein said step of causing a large valve overlap includes providing a valve overlap of at least 50 crank angle degrees.

16. A method of operating an engine as defined in claim 13, further comprising the step of operating at least one of the camshafts by a variable camshaft timing device based on the engine load condition determined in said step of determining so that the engine can operate using spark ignition with a reduced internal EGR when the engine is in a full load condition.

17. A method of operating an engine as defined in claim 16, wherein said step of operating when the engine is in a full load condition includes retarding the spark timing.

18. A method of operating an engine as defined in claim 16, wherein said step of operating when the engine is in a full load condition includes reducing an effective compression ratio by using late intake valve closing timing.

19. A method of operating an engine as defined in claim 13, further comprising the step of operating one of the intake valves and the exhaust valve by the second camshaft.

20. A method of operating an engine as defined in claim 13, wherein the engine comprises two exhaust valves and two intake valves and said method further comprising the steps of operating the intake valves by the first camshaft and operating the exhaust valves by the second camshaft.
